(19) United States
(12) Patent Application Publication
(10) Pub. No.: US 2022/0200490 A1
(43) Pub. Date: Jun. 23, 2022

(54) MOTOR CONTROL METHOD AND SYSTEM

(71) Applicant: SHENZHEN ZHAOWEI MACHINERY & ELECTRONICS CO., LTD., Guandong (CN)

(72) Inventors: Yidong CHEN, Guangdong (CN); Zijian LEI, Guangdong (CN); Ping LI, Guangdong (CN)

(73) Assignee: SHENZHEN ZHAOWEI MACHINERY & ELECTRONICS CO., LTD., Guandong (CN)

(21) Appl. No.: 17/609,047

(22) PCT Filed: Aug. 12, 2019
(86) PCT No.: PCT/CN2019/100254

§ 371 Date: Nov. 5, 2021

(30) Foreign Application Priority Data
May 10, 2019 (CN) 201910388448.8

(51) Int. Cl. H02P 5/50; H02P 5/685; H02P 6/04

(52) U.S. Cl. CPC H02P 5/50; H02P 6/04; H02P 5/685

(57) ABSTRACT

The present application relates to the technical field of motor control, and provides a motor control method and system. The motor control method includes: each driving chip receives state information fed back by a sensor corresponding to the driving chip; when the driving chip receives the state information, a processor receives the state information; the driving chip processes the state information to obtain a first control signal, and the processor processes the state information to obtain a second control signal; and at least two of a plurality of driving chips drive, according to the first control signals and the second control signals corresponding to the driving chips, motors corresponding to the driving chips for linkage.

### CROSS-REFERENCE TO RELATED APPLICATIONS

The present application claims the priority of the Chinese patent application filed with the Chinese Patent Office on May 10, 2019, with the application number of 201910388448.8 and entitled “Motor Control Method and System”, the entire content of which is incorporated into the present application by reference.

### TECHNICAL FIELD

The present application relates to the technical field of the motor control, and specifically, to a motor control method and system.

### BACKGROUND ART

A motor, as the power source for various mechanical equipment, has been widely used in many fields. A user can control the motor through the controller in the mechanical equipment according to actual needs, so that the working state of the motor can reach the state that the user desires.

In the related art, plural processors, plural motors, and plural power drive circuits are provided in the mechanical equipment. The processors are electrically connected with the power drive circuits in one-to-one correspondence, and the power drive circuits are electrically connected with the motors in one-to-one correspondence, wherein the number of processors, the number of power drive circuits, and the number of motors are the same. The individual processors can communicate with each other through a preset communication method. The individual processors can output corresponding control information according to the communication information, so that the associated movement (linkage) between plural motors can be realized.

However, in the prior art, one processor correspondingly controls one motor. When plural motors need to be controlled to perform associated movement, the number of processors required will also increase, causing the problem of excessively high costs when controlling motors to perform the associated movement.

### SUMMARY

The purpose of the present application is to provide a motor control method and system in view of the above-mentioned deficiencies in the prior art, so as to solve the problem of the prior art in which one processor correspondingly controls one motor and when plural motors need to be controlled to perform associated movement, the number of processors required will also increase, causing the excessively high costs when controlling motors to perform the associated movement.

To achieve the foregoing purpose, the technical solutions adopted in the embodiments of the present application are as follows.

In the first aspect, an embodiment of the present application provides a motor control method, applicable to a motor control system, wherein the motor control system comprises a processor, a plurality of driving chips, motors connected to the individual driving chips, and sensors corresponding to the individual motors, wherein each of the driving chips is respectively connected to a corresponding motor, a corresponding sensor, and the processor, and the sensors are each connected to the processor, wherein the method comprises steps of:

receiving, by each of the driving chips, status information fed back by the sensor corresponding to the driving chip, with the status information used to indicate a working status of the motor corresponding to the driving chip;

receiving, by the processor, the status information, when the driving chip receives the status information;

the driving chip performing process on the status information, to obtain a first control signal, and the processor performing process on the status information, to obtain a second control signal; and

driving, by at least two of the plurality of driving chips, the motors corresponding to the individual driving chips to perform an associated movement, according to the first control signal and the second control signal corresponding to the individual driving chips.

Further, before the driving chip receives the status information fed back by the sensor corresponding to the driving chip, the method further comprises:

collecting, by each of the sensors, status information of the motor connected thereto, with the status information used to indicate a working state of the motor; and

sending respectively, by each of the sensors, the status information to the processor and the corresponding driving chip.

Further, the driving chip comprises a decoding circuit, and the step of the driving chip performing process on the status information to obtain a first control signal comprises:

the driving chip decoding the status information through the decoding circuit to obtain the first control signal, with the first control signal used to indicate whether a motor corresponding to the driving chip is operating abnormally.

Further, the step of driving, by at least two of the plurality of driving chips, the motors corresponding to the individual driving chips to perform an associated movement, according to the first control signal and the second control signal corresponding to the individual driving chips, comprises:

the processor sending a second control signal corresponding to each of the driving chips to at least two of the driving chips; and

driving, by at least two of the driving chips, the motors corresponding to the individual driving chips to perform an associated movement, according to the first control signal and the second control signal corresponding to the individual driving chips.

Further, the step of driving, by at least two of the plurality of driving chips, the motors corresponding to the individual driving chips to perform an associated movement, according to the first control signal and the second control signal corresponding to the individual driving chips, comprises:

at least two of the driving chips, if each of the at least two first control signals indicates that the motor is normal, driving the motors corresponding to the individual driving chips to perform an associated movement, according to the at least two second control signals; and

at least two of the driving chips, if any one of the at least two first control signals indicates that the motor is abnormal, stopping driving the motors corresponding to the individual driving chips to perform an associated movement.

In the second aspect, embodiments of the present application further provide a motor control system, wherein the motor control system comprises a processor, a plurality of driving chips, motors connected to the individual driving chips, and sensors corresponding to the individual motors, wherein each of the driving chips is respectively connected to a corresponding motor, a corresponding sensor, and the processor, and the sensors are each connected to the processor, wherein

each of the driving chips is configured to receive status information fed back by the sensor corresponding to the driving chip, with the status information used to indicate a working status of the motor corresponding to the driving chip;

the processor is configured to receive the status information, when the driving chip receives the status information;

the driving chip is configured to perform process on the status information to obtain a first control signal, and the processor is configured to perform process on the status information to obtain a second control signal; and

at least two of the plurality of driving chips are configured to drive the motors corresponding to the individual driving chips to perform an associated movement, according to the first control signal and the second control signal corresponding to the individual driving chips.

Further, each of the sensors is configured to collect status information of the motor connected thereto, with the status information used to indicate a working state of the motor; and

each of the sensors is configured to send respectively the status information to the processor and the corresponding driving chip.

Further, the driving chip comprises a decoding circuit;

the driving chip is further configured to decode the status information through the decoding circuit to obtain the first control signal, with the first control signal used to indicate whether a motor corresponding to the driving chip is operating abnormally.

Further, the processor is further configured to send a second control signal corresponding to the individual driving chips to at least two of the driving chips; and

at least two of the driving chips are further configured to drive the motors corresponding to the individual driving chips to perform an associated movement, according to the first control signal and the second control signal corresponding to the individual driving chips.

Further, at least two of the driving chips are configured to drive the motors corresponding to the individual driving chips to perform an associated movement, according to the at least two second control signals, if each of the at least two first control signals indicates that the motor is normal; and

at least two of the driving chips are configured to stop driving the motors corresponding to the individual driving chips to perform an associated movement, if any one of the at least two first control signals indicates that the motor is abnormal.

The beneficial effects of the present application are: in the motor control method and system provided by the embodiments of the present application, each of the driving chips receives status information fed back by the sensor corresponding to the driving chip; the processor receives the status information, when the driving chip receives the status information; the driving chip performs process on the status information to obtain a first control signal, and the processor performs process on the status information to obtain a second control signal; and at least two of the plurality of driving chips drive the motors corresponding to the individual driving chips to perform an associated movement, according to the first control signal and the second control signal corresponding to the individual driving chips. One processor can receive the status information fed back by plural sensors, and process the status information to obtain the second control signal corresponding to each motor. The at least two driving chips, according to the first control signal and the second control signal corresponding to the individual driving chips, drive the motors corresponding to the individual driving chips to perform the associated movement. It is possible to use only one processor to realize controlling plural motors to perform the associated movement, avoiding the problem of excessively high cost when controlling motors to perform the associated movement and reducing the cost for controlling motors to perform the associated movement.

### BRIEF DESCRIPTION OF DRAWINGS

In order to explain more clearly the technical solutions of the embodiments of the present application, the drawings that need to be used in the embodiments will be briefly introduced as follows. It should be understood that the following drawings only show certain embodiments of the present application, and therefore they should not be regarded as limitation to the protection scope. For those ordinarily skilled in the art, without inventive work, other related drawings can be obtained from these drawings.

FIG. 1 is a schematic structural diagram of a motor control system related to a motor control method provided by an embodiment of the present application;

FIG. 2 is a schematic structural diagram of a motor control system provided by an embodiment of the present application;

FIG. 3 is a schematic flowchart of a motor control method provided by an embodiment of the present application; and

FIG. 4 is a schematic flowchart of a motor control method provided by an embodiment of the present application.

### DETAILED DESCRIPTION OF EMBODIMENTS

In order to make the purposes, technical solutions and advantages of the embodiments of the present application clearer, the technical solutions in the embodiments of the present application will be described clearly and completely in conjunction with the drawings in the embodiments of the present application. Obviously, the described embodiments are a part of the embodiments of the present application, instead of all of the embodiments.

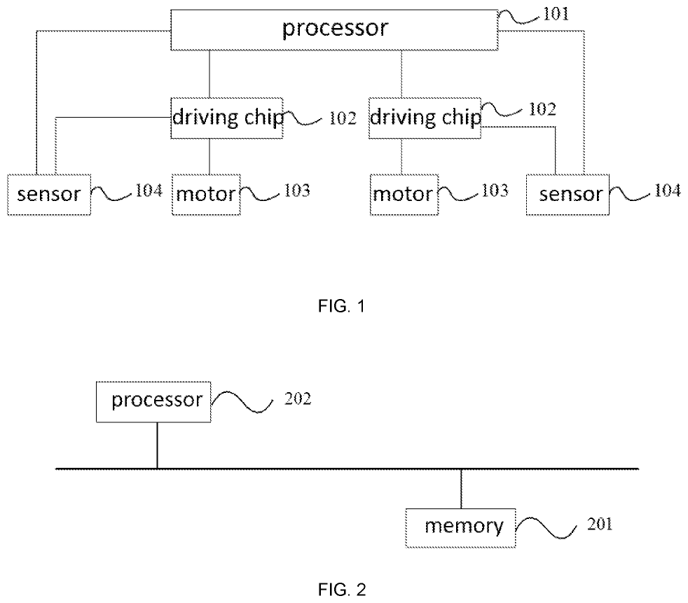

FIG. 1 is a schematic structural diagram of a motor control system related to a motor control method provided by an embodiment of the present application. As shown in FIG. 1, the motor control system comprises: a processor 101, a plurality of driving chips 102, motors 103 connected to the individual driving chips 102, and sensors 104 corresponding to the individual motors 103.

Herein, each driving chip is respectively connected with the corresponding motor, the corresponding sensor and a processor, and each sensor is connected with the processor.

Each of the driving chips is configured to receive status information fed back by the sensor corresponding to the driving chip, with the status information used to indicate a working status of the motor corresponding to the driving chip.

The processor is configured to receive the status information, when the driving chip receives the status information.

The driving chip is configured to perform process on the status information to obtain a first control signal, and the processor is configured to perform process on the status information to obtain a second control signal.

At least two of the plurality of driving chips are configured to drive the motors corresponding to the individual driving chips to perform an associated movement, according to the first control signal and the second control signal corresponding to the individual driving chips.

In order to avoid the problem of high cost when controlling the motors to perform the associated movement, which problem is caused by plural processors controlling plural motors, it is possible that when one processor is used to control plural motors to perform the associated movement, the control information for controlling the individual motors can be sent to each driving chip, such that it is realized that one processor is used to control plural motors to perform the associated movement therebetween, which reduces the number of processors required when controlling the plural motors to perform the associated movement, and reduces the cost of controlling the motors to perform the associated movement.

Specifically, at least two driving chips receive the status information fed back by the sensors corresponding to the at least two driving chips, the processor may also receive the status information. The at least two driving chips may process the status information to obtain the first control signal, and the processor can process the status information to obtain the second control signal. The at least two driving chips can drive, according to the first control signal and the second control signal corresponding to the at least two driving chips, the motors corresponding to the at least two driving chips, to perform the associated movement.

In addition, FIG. 1 is the schematic structural diagram only showing that the processor controls two motors to perform the associated movement. In practical applications, the number of motors, which are controlled by the processor to perform the associated movement, may be 2, or 3, or other numbers, which is not specifically limited in the present application.

Optionally, each of the sensors is configured to collect status information of the motor connected thereto, with the status information used to indicate a working state of the motor.

Each of the sensors is further configured to send respectively the status information to the processor and the corresponding driving chip.

Optionally, the driving chip comprises a decoding circuit.

The driving chip is further configured to decode the status information through the decoding circuit to obtain the first control signal, with the first control signal used to indicate whether a motor corresponding to the driving chip is operating abnormally.

Optionally, the processor is further configured to send a second control signal corresponding to the individual driving chips to at least two of the driving chips.

At least two of the driving chips are further configured to drive the motors corresponding to the individual driving chips to perform an associated movement, according to the first control signal and the second control signal corresponding to the individual driving chips.

Optionally, at least two of the driving chips are configured to drive the motors corresponding to the individual driving chips to perform an associated movement, according to the at least two second control signals, if each of the at least two first control signals indicates that the motor is normal.

At least two of the driving chips are further configured to stop driving the motors corresponding to the individual driving chips to perform an associated movement, if any one of the at least two first control signals indicates that the motor is abnormal.

In practical applications, the processor can control a group of motors to perform an associated movement, and it is also possible to control two groups of motors to perform an associated movement, or control plural groups of motors to perform an associated movement, which is not specifically limited in the present application, wherein one group of motors can comprise plural motors that can perform an associated movement.

For example, a motor control system can comprise six motors, three of which can be used as the first group of motors, and the processor can control the three motors in the first group to perform the associated movement. The remaining three motors can be used as the second group of motors, and the processor can control the three motors in the second group to perform the associated movement, that is, the processor can control the two groups of motors to perform the associated movement.

To sum up, in the motor control system provided by the embodiments of the present application, each of the driving chips receives status information fed back by the sensor corresponding to the driving chip; the processor receives the status information, when the driving chip receives the status information; the driving chip performs process on the status information to obtain a first control signal, and the processor performs process on the status information to obtain a second control signal; and at least two of the plurality of driving chips drive the motors corresponding to the individual driving chips to perform an associated movement, according to the first control signal and the second control signal corresponding to the individual driving chips. One processor can receive the status information fed back by plural sensors, and process the status information to obtain the second control signal. The at least two driving chips, according to the first control signal and the second control signal corresponding to the individual driving chips, drive the motors corresponding to the individual driving chips to perform the associated movement, avoiding the problem of excessively high cost when controlling the motors to perform the associated movement and reducing the cost for controlling motors to perform the associated movement.

The above system is configured to execute the method provided in the following embodiment, with similar implementation principles and technical effects, which will not be repeated here.

The above systems may be one or more integrated circuits configured to implement the above method, for example, one or more specific integrated circuits (Application Specific Integrated Circuit, ASIC for short), or one or more microprocessors (digital signal processor, DSP for short), or one or more Field Programmable Gate Array (FPGA for short), etc. As another example, when a certain system above is implemented in the form that the processing element calls the program codes, the processing element may be a general-purpose processor, such as, a Central Processing Unit (CPU for short) or other processors that can call program codes. As another example, these systems can be integrated together and implemented in the form of a system-on-a-chip (SOC for short).

FIG. 2 is a schematic structural diagram of a motor control system provided by an embodiment of the present application. The system may be integrated in a terminal device or a chip of a terminal device, and the terminal may be a computing device with a data processing function.

The system comprises: a memory 201 and a processor 202.

The memory 201 is configured to store a program, and the processor 202 calls the program stored in the memory 201 to execute the following method embodiment. The specific implementation and the technical effect are similar, and they will not be repeated here.

Optionally, the present application also provides a program product, such as a computer-readable storage medium, comprising a program, which is configured to execute the following method embodiment when executed by a processor.

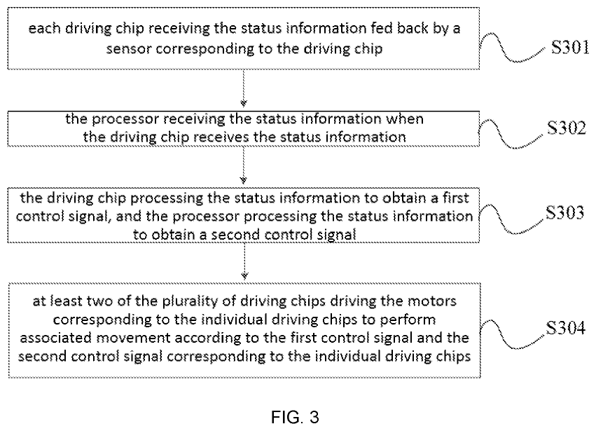

FIG. 3 is a schematic flowchart of a motor control method provided by an embodiment of the present application. As shown in FIG. 3, it is applicable to the motor control system described in the foregoing embodiment, and the method comprises:

S301: each driving chip receiving the status information fed back by a sensor corresponding to the driving chip.

Herein, the status information is used to indicate the working status of the motor corresponding to the driving chip, and the sensors, the driving chips and the motors all are in the one-to-one correspondence.

In order to control the associated movement of plural motors, the driving chip corresponding to each motor needs to receive the working state of the corresponding motor, so that in the subsequent steps, each driving chip obtains the first control signal according to the working state of the corresponding motor, so as to realize the control on the corresponding motor.

It should be noted that since each motor runs in real time, the driving chip can receive the status information of the motor fed back by the sensor in real time, so that each driving chip can obtain the status information of each corresponding motor.

S302: the processor receiving the status information when the driving chip receives the status information.

Since the motor needs to be driven by the processor and the driving chip together, in order to control the associated movement of plural motors, the processor also needs to obtain the status information of each motor, so that in the subsequent steps, the processor can perform process on the operation status of the corresponding motor to obtain the second control signal, so that the associated movement of the motors can be realized through the second control signal.

Specifically, when each driving chip can receive the status information of the corresponding motor fed back by the corresponding sensor, the processor can also receive the status information of the corresponding motor fed back by the corresponding sensor, so that each driving chip can obtain the status information of the corresponding motor, and the processor can also obtain the status information of the motor.

S303: the driving chip processing the status information to obtain a first control signal, and the processor processing the status information to obtain a second control signal.

Herein, the first control signal is used to indicate whether the motor is working abnormally, the second control signal is used to indicate the rotational speed information and steering information of the motor, and the driving chip can enter the low power consumption mode or drive the corresponding motor to operate according to the second control signal.

After the driving chip and the processor respectively receive the status information, the driving chip needs to obtain the first control signal according to its own processing and the second control signal obtained by the processing of the processor, to drive the motors corresponding to the individual driving chips to perform the associated movement, so that the driving chip and the processor need to process the status information to obtain the first control signal and the second control signal.

Specifically, each driving chip can process the status information by means of decoding, to obtain the first control signal used to control the corresponding motor. At the same time, the processor can process the status information through a preset algorithm to obtain the second control signal used to control the corresponding motor.

S304: at least two of the plurality of driving chips driving the motors corresponding to the individual driving chips to perform associated movement according to the first control signal and the second control signal corresponding to the individual driving chips.

After the driving chip processes the status information to obtain the first control signal and the processor processes the status information to obtain the second control signal, the driving chip can drive the motors corresponding to the individual driving chips to perform associated movement according to the first control signal and the second control signal corresponding to the individual driving chips, so as to realize the associated movement between the motors.

Specifically, the processor may send the corresponding second control signal to at least two driving chips, and the at least two driving chips may receive the corresponding second control signal, and amplify the second control signal to obtain the amplified second control signal, and at least two driving chips can drive the motors corresponding to individual driving chips to perform associated movement according to the first control signal and the amplified second control signal corresponding to individual driving chips.

It should be noted that in practical application, if each first control signal indicates that the motor is normal, at least two driving chips can drive the motors corresponding to individual driving chips to perform associated movement according to the at least two second control signals.

However, if a certain first control signal indicates that the motor is abnormal, at least two driving chips may stop driving the motors corresponding to individual driving chips to perform associated movement.

In summary, in the motor control method provided by the embodiments of the present application, each of the driving chips receives status information fed back by the sensor corresponding to the driving chip; the processor receives the status information, when the driving chip receives the status information; the driving chip performs process on the status information to obtain a first control signal, and the processor performs process on the status information to obtain a second control signal; and at least two of the plurality of driving chips drive the motors corresponding to the individual driving chips to perform an associated movement, according to the first control signal and the second control signal corresponding to the individual driving chips. One processor can receive the status information fed back by plural sensors, and process the status information to obtain the second control signal corresponding to each motor. The at least two driving chips, according to the first control signal and the second control signal corresponding to the individual driving chips, drive the motors corresponding to the individual driving chips to perform the associated movement. It is possible to use only one processor to realize controlling plural motors to perform the associated movement, avoiding the problem of excessively high cost when controlling motors to perform the associated movement and reducing the cost for controlling motors to perform the associated movement.

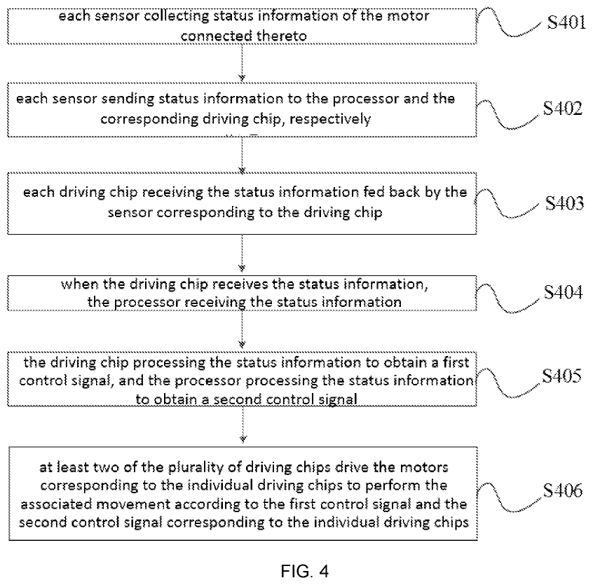

FIG. 4 is a schematic flowchart of a motor control method provided by an embodiment of the present application. As shown in FIG. 4, it is applicable to the motor control system described in the foregoing embodiment, and the method comprises:

S401: each sensor collecting status information of the motor connected thereto.

Herein, the status information is used to indicate the working status of the motor.

When controlling, through the controller and the corresponding driving chip, the corresponding driving chip to perform the associated movement, it needs to be processed according to the current working state of the motor, so that the corresponding control signal can be obtained to control the motors to perform the associated movement, and therefore, each sensor needs to collect the status information of the motor connected thereto.

In the embodiment of the present application, each sensor can be arranged in the corresponding motor, so that the status information of the corresponding motor during operation can be collected.

In addition, the type of the sensor in the embodiment of the present application may be a Hall sensor, and the Hall sensor collects status information of the corresponding motor.

S402: each sensor sending status information to the processor and the corresponding driving chip, respectively.

After each sensor collects in real time the status information of the motor connected thereto, in order that the driving chip can control the corresponding motor to perform the associated movement according to the corresponding first control signal and the second control signal, each sensor sends in real time the status information respectively to the processor and the corresponding the driving chip.

It should be noted that each motor has a sensor, a driving chip, and status information of the motor which the sensor collects, which are corresponding to the motor.

S403: each driving chip receiving the status information fed back by the sensor corresponding to the driving chip.

The process of step 403 is similar to the process of step 401, and will not be repeated here.

S404: when the driving chip receives the status information, the processor receiving the status information.

The process of step 404 is similar to the process of step 402, and will not be repeated here.

S405: the driving chip processing the status information to obtain a first control signal, and the processor processing the status information to obtain a second control signal.

The driving chip and the processor need to process the status information to obtain the first control signal and the second control signal, so that in the subsequent steps, the driving chip can drive the motor corresponding to each driving chip to perform the associated movement based on the first control signal and the second control signal corresponding to each driving chip.

In a possible embodiment, the processor can recognize the rotational speed information of the corresponding motor contained in the status information fed back by each sensor through a preset algorithm. When the processor detects that the motors performing the associated movement have different rotational speeds, the processor can obtain the second control signal to corresponding motor according to the preset algorithm.

Optionally, the driving chip decodes the status information through the decoding circuit to obtain the first control signal, and the first control signal is used to indicate whether the motor corresponding to the driving chip is working abnormally.

In a possible embodiment, the driving chip decodes the status information through the decoding circuit to obtain the decoded information. The decoded information can control the output logic of the three-phase inverter bridge in the driving chip, that is, obtain the first control signal, through which the motor is controlled to work abnormally or not.

For example, the type of the sensor can be a Hall sensor, and the status information of the motor collected by the sensor can be a Hall signal, and the driving chip can decode the Hall signal through a decoding circuit to obtain a decoded Hall signal, and the decoded Hall signal can turn on and off the field effect transistor in the corresponding three-phase inverter bridge, and then the output logic of the three-phase inverter bridge, that is, the first control signal can be obtained. The motor is controlled to work abnormally or not through the first control signal.

S406: at least two of the plurality of driving chips drive the motors corresponding to the individual driving chips to perform the associated movement according to the first control signal and the second control signal corresponding to the individual driving chips.

In order to realize the associated movement between the motors, at least two of the plural driving chips are required to control the corresponding motors according to the first control signal and the second control signal corresponding to the individual driving chips, so that the working statuses of the plural motors are the same.

Optionally, the processor sends the second control signal corresponding to individual driving chips to at least two driving chips, and the at least two driving chips drive the motors corresponding to the individual driving chips to perform the associated movement according to the first control signal and the second control signal corresponding to the individual driving chips.

Herein, the processor sends the second control signal corresponding to the individual driving chips to at least two driving chips, and the at least two driving chips can amplify the corresponding second control signal.

Optionally, if each of the at least two first control signals indicates that the motor is normal, the at least two driving chips drive the motors corresponding to the individual driving chips to perform the associated movement according to the at least two second control signals, and if any one of the at least two first control signals indicates that the motor is abnormal, the at least two driving chips stop driving the motors corresponding to the individual driving chips to perform the associated movement.

Herein, it is possible to set each motor with a resistor corresponding to the each motor, and each resistor is respectively connected to the corresponding motor and the driving chip, and the current generated when the motor is working is detected through each resistor.

Specifically, if any one of the first control signals indicates that the motor works abnormally, the corresponding motor starts to work abnormally, and the current information detected by the corresponding at least two resistors is too large, and at least two driving chips can obtain the current information and feedback it to the processor. After receiving the current information, the processor controls the at least two driving chips to stop driving the corresponding motors, and stop sending to the at least two driving chips the second control signal used to control the motors to perform the associated movement.

To sum up, in the motor control method provided by the embodiments of the present application, each of the driving chips receives status information fed back by the sensor corresponding to the driving chip; the processor receives the status information, when the driving chip receives the status information; the driving chip performs process on the status information to obtain a first control signal, and the processor performs process on the status information to obtain a second control signal; and at least two of the plurality of driving chips drive the motors corresponding to the individual driving chips to perform an associated movement, according to the first control signal and the second control signal corresponding to the individual driving chips. One processor can receive the status information fed back by plural sensors, and process the status information to obtain the second control signal corresponding to the individual motors. The at least two driving chips, according to the first control signal and the second control signal corresponding to the individual driving chips, drive the motors corresponding to the individual driving chips to perform the associated movement. It is possible to use only one processor to realize controlling plural motors to perform the associated movement, avoiding the problem of excessively high cost when controlling the motors to perform the associated movement and reducing the cost for controlling motors to perform the associated movement.

In the several embodiments provided in the present application, it should be understood that the disclosed system and method can be implemented in other ways. For example, the system embodiment described above is only illustrative. For example, the division of the units is only a division in terms of logical function. In practical, the division may be made in other way. For example, plural units or components can be combined or they can be integrated into another system, or some features can be ignored or not implemented. In addition, as displayed or discussed, the mutual coupling or the direct coupling or the communication connection may be indirect coupling or communication connection through some interfaces, systems or units, which may be in electrical, mechanical or other forms.

The units described as separate components may or may not be physically separated. The components displayed as a unit may or may not be a physical unit, that is, they may be located in one place, or they may be distributed on plural units in the network. Some or all of the units may be selected according to actual needs to achieve the objectives of the technical solutions of the embodiments.

In addition, the functional units in the various embodiments of the present application may be integrated into one processing unit, or each unit may exist alone physically, or two or more units may be integrated into one unit. The above-mentioned integrated unit may be implemented in the hardware form, or may be implemented in the form of the hardware plus the software functional unit.

The above-mentioned integrated unit implemented in the form of a software functional unit may be stored in a computer readable storage medium. The above-mentioned software functional unit is stored in the storage medium, comprising plural instructions to make a computer device (which can be a personal computer, a server, or a network device, etc.) or a processor execute part of steps of the method of the various embodiments of the present application. The aforementioned storage media comprise various media that can store program codes, such as: U disk, mobile hard disk, read-only memory (ROM for short), random access memory (RAM for short), magnetic disk or optical disk.

What is claimed is:

1. A motor control method, applicable to a motor control system, wherein the motor control system comprises a processor, a plurality of driving chips, motors connected to the individual driving chips, and sensors corresponding to the individual motors, wherein each of the driving chips is respectively connected to a corresponding motor, a corresponding sensor, and the processor, and the sensors are each connected to the processor, wherein the method comprises steps of:
receiving, by each of the driving chips, status information fed back by a sensor corresponding to each of the driving chips, with the status information used to indicate a working status of a motor corresponding to each of the driving chips;
receiving, by the processor, the status information, when each of the driving chips receives the status information;
each of the driving chips performing a process on the status information, to obtain a first control signal, and the processor performing a process on the status information, to obtain a second control signal; and
driving, by at least two of the plurality of driving chips, the motors corresponding to the individual driving chips to perform an associated movement, according to the first control signal and the second control signal corresponding to each of the driving chips.

2. The method according to claim 1, wherein before each of the driving chips receives the status information fed back by the sensor corresponding to each of the driving chips, the method further comprises:
collecting, by each of the sensors, status information of a motor connected thereto, with the status information used to indicate a working state of the motor; and
sending respectively, by each of the sensors, the status information to the processor and a corresponding driving chip.

3. The method according to claim 1, wherein each of the driving chips comprises a decoding circuit, and the step of each of the driving chips performing a process on the status information, to obtain a first control signal comprises:
each of the driving chips decoding the status information through the decoding circuit to obtain the first control signal, with the first control signal used to indicate whether a motor corresponding to each of the driving chips is operating abnormally.

4. The method according to claim 1, wherein the step of driving, by at least two of the plurality of driving chips, the motors corresponding to the individual driving chips to perform an associated movement, according to the first control signal and the second control signal corresponding to each of the driving chips, comprises:
the processor sending a second control signal corresponding to each of the driving chips to at least two of the driving chips; and
driving, by at least two of the driving chips, the motors corresponding to the individual driving chips to perform an associated movement, according to the first control signal and the second control signal corresponding to each of the driving chips.

5. The method according to claim 4, wherein the step of driving, by at least two of the plurality of driving chips, the motors corresponding to the individual driving chips to perform an associated movement, according to the first control signal and the second control signal corresponding to each of the driving chips, comprises:
at least two of the driving chips, if each of at least two first control signals indicates that a corresponding motor is normal, driving the motors corresponding to the individual driving chips to perform an associated movement, according to at least two second control signals; and
at least two of the driving chips, if any one of at least two first control signals indicates that a corresponding is abnormal, stopping driving the motors corresponding to the individual driving chips to perform an associated movement.

6. A motor control system, wherein the motor control system comprises a processor, a plurality of driving chips, motors connected to the individual driving chips, and sensors corresponding to the individual motors, wherein each of the driving chips is respectively connected to a corresponding motor, a corresponding sensor, and the processor, and the sensors are each connected to the processor, wherein
each of the driving chips is configured to receive status information fed back by a sensor corresponding to each of the driving chips, with the status information used to indicate a working status of a motor corresponding to each of the driving chips;
the processor is configured to receive the status information, when each of the driving chips receives the status information;
each of the driving chips is configured to perform process on the status information to obtain a first control signal, and the processor is configured to perform process on the status information to obtain a second control signal; and
at least two of the plurality of driving chips are configured to drive the motors corresponding to the individual driving chips to perform an associated movement, according to the first control signal and the second control signal corresponding to each of the driving chips.

7. The motor control system according to claim 6, wherein each of the sensors is configured to collect status information of a motor connected thereto, with the status information used to indicate a working state of the motor; and
each of the sensors is further configured to send respectively the status information to the processor and a corresponding driving chip.

8. The motor control system according to claim 6, wherein each of the driving chips comprises a decoding circuit; and
each of the driving chips is further configured to decode the status information through the decoding circuit to obtain the first control signal, with the first control signal used to indicate whether a motor corresponding to each of the driving chips is operating abnormally.

9. The motor control system according to claim 6, wherein the processor is further configured to send a second control signal corresponding to each of the driving chips to at least two of the driving chips; and
at least two of the driving chips are further configured to drive the motors corresponding to the individual driving chips to perform an associated movement, according to the first control signal and the second control signal corresponding to each of the driving chips.

10. The motor control system according to claim 9, wherein at least two of the driving chips are further configured to drive the motors corresponding to the individual driving chips to perform an associated movement, according to at least two second control signals, if each of at least two first control signals indicates that a corresponding motor is normal; and
at least two of the driving chips are further configured to stop driving the motors corresponding to the individual driving chips to perform an associated movement, if any one of at least two first control signals indicates that a corresponding motor is abnormal.
